(19) United States
(12) Patent Application Publication
(10) Pub. No.: US 2016/0055180 A1
(43) Pub. Date: Feb. 25, 2016

(54) NON-TRANSITORY RECORDING MEDIUM, INFORMATION PROCESSING DEVICE, AND METHOD

(71) Applicant: FUJI XEROX CO., LTD., Tokyo (JP)

(72) Inventor: Kazunori NISHIHARA, Kanagawa (JP)

(21) Appl. No.: 14/597,710

(22) Filed: Jan. 15, 2015

(30) Foreign Application Priority Data
Aug. 20, 2014 (JP) 2014-167752

(51) Int. Cl. G06F 17/30

(52) U.S. Cl. CPC G06F 17/30268; G06F 17/3087; G06F 17/30256

(57) ABSTRACT

A non-transitory computer readable medium stores a program causing a computer to execute a process that includes storing keywords related to a template image for every template image, acquiring a search result of information on the Internet that includes information of a location and a time that correspond to image capture location information and image capture time information included in photo image data, and selecting a stored template image with related keywords that are highly relevant to a keyword group included in the search result as a template image relevant to the photo image data.

### CROSS-REFERENCE TO RELATED APPLICATIONS

This application is based on and claims priority under 35 USC 119 from Japanese Patent Application No. 2014-167752 filed Aug. 20, 2014.

### BACKGROUND

### Technical Field

The present invention relates to a non-transitory recording medium, an information processing device, and a method.

### SUMMARY

According to an aspect of the invention, there is provided a non-transitory computer readable medium storing a program causing a computer to execute a process that includes storing keywords related to a template image for every template image, acquiring a search result of information on the Internet that includes information of a location and a time that correspond to image capture location information and image capture time information included in photo image data, and selecting a stored template image with related keywords that are highly relevant to a keyword group included in the search result as a template image relevant to the photo image data.

### BRIEF DESCRIPTION OF THE DRAWINGS

An exemplary embodiment of the present invention will be described in detail based on the following figures, wherein:

FIG. 1 is a diagram illustrating an exemplary configuration of a template adding device according to an exemplary embodiment;

FIG. 2 is a diagram illustrating an example of association information stored in a template/keyword association storage unit;

FIG. 3 is a diagram illustrating another example of association information stored in a template/keyword association storage unit;

FIG. 4 is a diagram illustrating an exemplary device configuration of an exemplary modification that converts the latitude/longitude of a geotag extracted from a photo image file into a place name or the like for use as a search condition of a search site; and

FIG. 5 is a diagram illustrating an exemplary device configuration of an exemplary modification that changes the geographical range of image capture location information to send to a search site according to whether or not the photo image is a landscape image.

### DETAILED DESCRIPTION

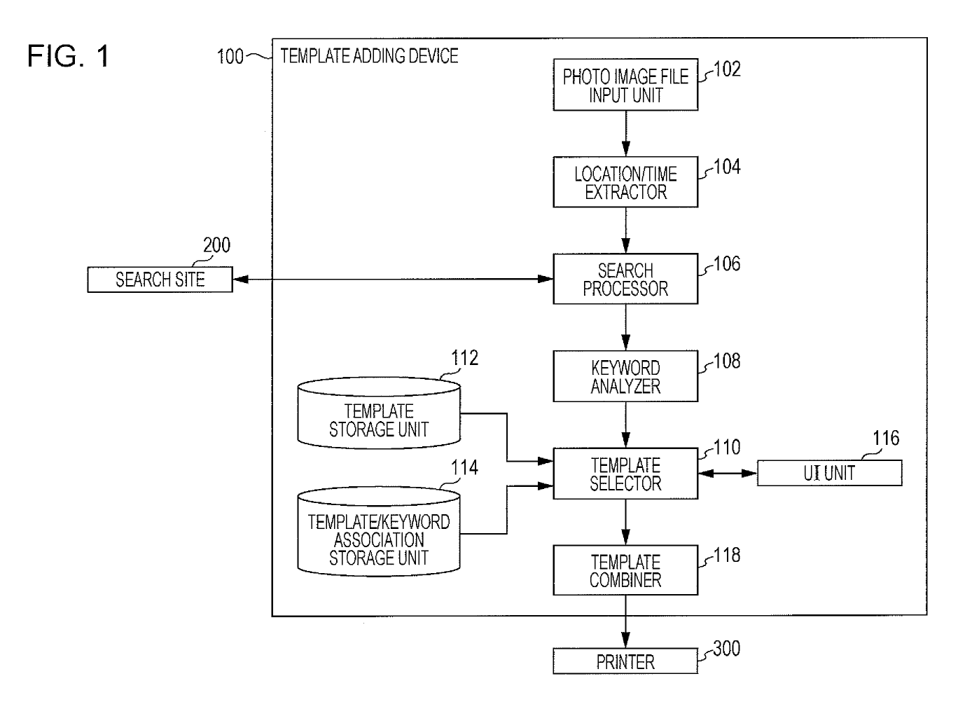

An exemplary embodiment of a device according to the present invention will be described with reference to FIG. 1. The template adding device 100 according to the exemplary embodiment combines a photo image input by a user with a template image relevant to the photo image.

Herein, to identify a template image relevant to a photo image, the exemplary embodiment uses image capture location information and image capture time information included in the file of the photo image. For example, a photo image file in the Exchangeable image file format (Exif) includes an image capture time obtained from a clock or the like built into the camera that captured the relevant photo image, as well as information about the image capture location (for example, latitude and longitude; also called a geotag) obtained from a Global Positioning System (GPS) device built into the camera. Such image capture time and latitude/longitude information is utilized, for example.

In the related art, associations between template images and combinations of an image capture location and an image capture time are pre-registered in a database, thereby enabling identification of a template image relevant to the image capture location and image capture time of a photo image.

In contrast, in the exemplary embodiment, template images are associated with one or more keywords and registered in a database. Subsequently, a keyword related to the combination of the image capture location and the image capture time of a photo image is identified from information on the Internet, and the database is searched for a template image corresponding to the identified keyword.

For example, in the case of enabling identification of a template image relevant to a photo image of an event held at a certain time and location, the technique of the related art requires that registering an association between the template image and that time and location in a database in advance. In contrast, with the technique of the exemplary embodiment, by utilizing information about the event posted by various people on the Internet, such as the World Wide Web (WWW), for example, such advance registration may be omitted.

In other words, if information about the time and location at which the event is held is included in the information about the event posted on the Internet, that information may be retrieved by conducting a search using the image capture time and location of the photo image as a search key. In addition, the retrieved information ordinarily includes text information such as a description and impressions of the event, and there is a high probability that the text information includes a keyword group expressing features of the event. Meanwhile, template images are managed in association with one or more keywords. These keywords are pre-registered by the database creator as data that expresses features of a photo image anticipated as an application of the template image, such as features of the event where the photo was captured (such as the name and genre of the event, and the type of location where the event is held, for example), and features of the image capture environment (such as the weather), for example. By extracting keywords from a large amount of information retrieved from the Internet using the image capture time and location of the photo image as a search key, and by searching for a template image having a keyword group that is highly relevant to the extracted keyword group, a template image with a high probability of being relevant to the photo image may be extracted.

To realize such a mechanism, the template adding device 100 exemplified in FIG. 1 includes a photo image file input unit 102, a location/time extractor 104, a search processor 106, a keyword analyzer 108, a template selector 110, a template storage unit 112, a template/keyword association storage unit 114, a user interface (UI) unit 116, and a template combiner 118.

The photo image file input unit 102 accepts, from the user, the input of a photo image file to be given a template. The method of inputting a photo image file is not particularly limited. For example, a photo image file may be read from a portable non-transitory recording medium such as an SD memory card carried by the user, or transferred from the user's mobile device via a wireless communication protocol such as Bluetooth (registered trademark).

The location/time extractor 104 extracts image capture time information and image capture location information from the input photo image file. If the photo image file is in Exif format, information about a date and time expressing the image capture time and information about the latitude and longitude of the image capture location is extracted.

The search processor 106 sends a search request specifying the image capture time information and the image capture location information extracted from the photo image file as a search key (search condition) to a search site 200 on the Internet, and obtains a search result for the search condition from the search site 200. Herein, the search key is treated as an AND condition of the image capture time information and the image capture location information. In addition, the image capture time and the image capture location extracted from the photo image file may be directly used as the search key, or the value of the most significant digits or a predetermined number of digits from among the extracted information may be used as the search key. For example, if the image capture time is saved in the photo image file at a precision up to units of seconds, and the latitude/longitude of the image capture location is saved at a precision up to the second decimal place of seconds, values such as the value of the image capture time up to units of days and the value of the latitude/longitude of the image capture location up to units of seconds may be used as the search key.

The search site 200 is a system that provides a search service for information such as webpages on the Internet, and may be a service such as Google (registered trademark), Yahoo! (registered trademark), or Baidu (registered trademark), for example. The search processor 106 accesses the search site 200 via the Internet using a protocol such as the Hypertext Transfer Protocol (HTTP), and sends a search request. The search site 200 searches for information such as webpages with a high relevance to the search key of the search request, and returns a search result webpage (hereinafter called the “search result page”) on which the Uniform Resource Locators (URLs) of the retrieved information are sorted in order of relevance. The information on the Internet that is searched by the search site 200 may include, for example, general webpages, blog posts, and public posts on a social networking service (SNS) such as Twitter (trademark) or Foursquare (trademark). In addition to the URLs of the retrieved information, in some cases the search result page returned by the search site 200 may also include an excerpt from each piece of information where the association with the search key is determined to be particularly strong.

The search processor 106 may also acquire the respective information by using the URL of each piece of information included in the search result received from the search site 200.

Although FIG. 1 only illustrates one search site 200, the search processor 106 may also transmit the search request to multiple search sites 200 on the Internet, and receive search results from the multiple search sites 200.

The keyword analyzer 108 extracts keywords from the information of the search result acquired by the search processor 106.

Herein, in one example, the keyword analyzer 108 acquires the information indicated by each URL in the search result page acquired by the search processor 106, and extracts keywords from the text information included in the acquired information. As another example, keywords may also be extracted from the text information of the search result page itself (including the partial excerpts related to the search key from each search result).

In addition, the keywords extracted by the keyword analyzer 108 may also be limited to those included in a keyword set prepared in advance. The keyword set is also a population of keywords to attach to a template image.

Additionally, the keyword analyzer 108 analyzes the keyword group extracted from the information of the search result, and computes features of the photo image to be given a template image. Features of the photo image is information reflecting the frequency of occurrence of each keyword in the search result (the respective information such as webpages that are relevant to the search key, or the search result page provided by the search site 200). Examples of features of a photo image and ways of computing features will be described in detail later.

The template selector 110 selects a template image from among the template images stored in the template storage unit 112 that is relevant to the features of the photo image computed by the keyword analyzer 108. Herein, the relevance of the keyword group associated with each template image stored in the template/keyword association storage unit 114 is computed with respect to the features of the photo image, and a template image having a higher relevance is considered to be more relevant to the photo image. The template selector 110 may also select the template image with the highest relevance as the template image to combine with the photo image. Additionally, as another example, multiple template images may be displayed on a screen in order of highest relevance as candidate templates, and the user may be made to select a template image to combine with the photo image from among the candidate templates. The screen display and acceptance of a selection from the user at this point is conducted via a display device and an input device provided in the user interface (UI) unit 116. The template image to be combined that is selected in this way is transmitted to the template combiner 118 together with the photo image to be given a template.

The template storage unit 112 stores multiple template images. Each template image is assigned unique template identification information (a template ID).

In the template/keyword association storage unit 114, for each template image, one or more keywords associated with the template image are registered in association with the template ID of the template image.

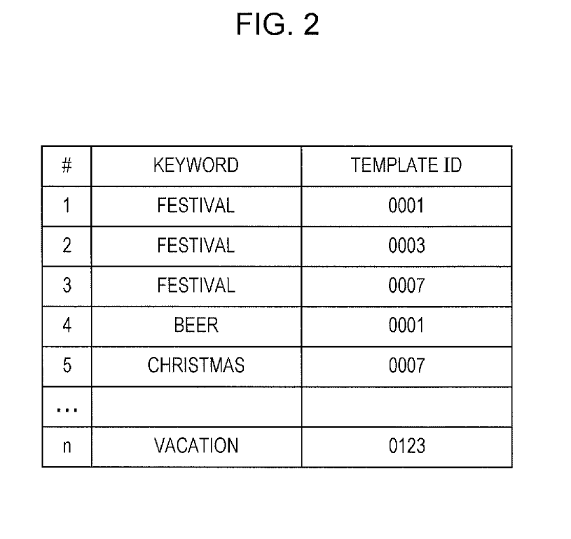

FIG. 2 illustrates an example of association information stored in the template/keyword association storage unit 114. In this example, keywords are registered in association with template IDs. The registered keywords are selected from a keyword set prepared in advance. The keyword set is the same as the keyword set that is the population of keywords that the keyword analyzer 108 extracts from the information of the search result.

In the example of FIG. 2, for example, the keyword “festival” is associated with three template images corresponding to the template IDs “0001”, “0003”, and “0007”. Also, the keyword “beer” is associated with the template image having the template ID “0001”. If the information exemplified in FIG. 2 is searched using a template ID as a key, one or more keywords associated with that template ID are obtained.

A collection of keywords associated with one template ID in this way may be treated as expressing features of the template image associated with the template ID.

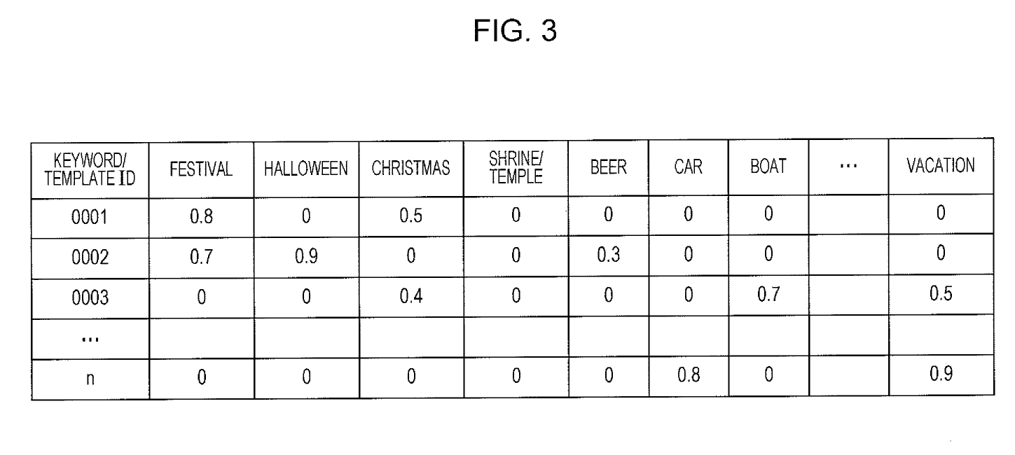

In addition, the association information stored in the template/keyword association storage unit 114 may also indicate the degree of association of each template image with respect to each keyword in the keyword set, as exemplified in FIG. 3. In the example of FIG. 3, one horizontal row indicates one template image, while each vertical column indicates a keyword. The values indicated in the cells at the intersections of the rows and columns indicates the degree of association of the template image corresponding to the relevant row with respect to the keyword corresponding to the relevant column. In this example, the degree of association of a template image with respect to a keyword is expressed as a real value from 0 to 1, with a greater numerical value indicating a stronger association. A degree of association of “0” indicates that the relevant template image is not associated with the relevant keyword at all. In FIG. 3, the collection of values of the degree of association with respect to each keyword arranged on a row corresponding to a template ID may also be treated as indicating the features of the template image corresponding to that template ID.

Note that the example illustrated in FIG. 2 may be treated as a special example of the association information of FIG. 3 for the case of limiting the degree of association to a binary value of “0” or “1”.

The association information stored in the template/keyword association storage unit 114 may be registered by a manager of the template adding device 100. Associations between template images and keywords basically may be registered once, without the burden of registering correspondence relationships between the time and location of an event (that is, some kind of occurrence) and a template image relevant to the event every time such an event occurs.

The template selector 110 references information stored in the template/keyword association storage unit 114, and calculates the relevance of each template image to the photo image to be given a template. Subsequently, a template image selected according to relevance is passed to the template combiner 118 together with the photo image to be given a template.

The template combiner 118 combines the template image and the photo image to be given a template received from the template selector 110. The image resulting from the combining, or in other words the photo image combined with a template image, is printed out from a printer 300.

The above thus describes an overall configuration of the template adding device 100 according to the exemplary embodiment. Next, the features of a photo image computed by the keyword analyzer 108 and ways of computing features will be described in further detail. The description below is roughly divided into two methods (A) and (B), which will be described in order.

(A) In one example, from among the keywords appearing in the search result obtained from the search site 200, a collection made up of a predetermined number of keywords of higher score computed on the basis of the frequency of occurrence of the relevant keyword is treated as the features of the photo image to be given a template.

Herein, the score of a keyword is taken to be the frequency of occurrence of the keyword in the respective information (for example, webpages) of the search result, summed over all of the retrieved information, for example. Herein, the range over which to sum may also be limited to a predetermined number of pieces of information in order of highest search rank (that is, a ranking sorted in order of highest relevance to the search key), for example.

In the example of taking the score of a keyword to be the sum of the frequency of occurrence of the keyword in each piece of information in the search result, the URL of each piece of information indicated on the search result page obtained from the search site 200 is used to acquire each piece of information. In contrast, as a simpler method, the frequency of occurrence of each keyword included in the text information of the search result page may be treated as the score for each keyword. Since this text information includes an excerpt of each piece of information together with the URL of each piece of information in the search result, the frequency of occurrence of each keyword in the group of excerpts is counted. At this point, since one search result page typically presents a predetermined number of URLs of information in the search result, in the case of summing the frequency of occurrence of the keywords over a predetermined number of pieces of information in order of highest search rank, the search processor 106 acquires a number of search result pages from the search site 200 to cover the predetermined number of highest-ranking pieces of information.

Also, when computing the score, instead of simply summing the frequency of occurrence of the keywords in each piece of information (or the excerpt from each piece of information) in the search result, a sum may be taken after weighting the frequency of occurrence in each piece of information according to the search rank of each piece of information. In this case, the weight value increases for a higher search rank. Consequently, a keyword appearing in information of higher relevance to the search key (the image capture time and the image capture location) contributes more to the score. Conversely, a keyword appearing in information of a lower search rank in the search result contributes less to the score.

Additionally, to cope with variation in the keyword frequency of occurrence for each piece of information in the search result, the frequency of occurrence of each keyword within individual pieces of information (such as webpages) may also be normalized by dividing by the sum of the frequency of occurrence of all keywords within the relevant piece of information. In other words, in this case, the score for one keyword may be treated as the normalized frequency of occurrence of the keyword in each piece of information in the search result, summed over all pieces of information in the search result.

Instead of treating the collection of keywords up to a predetermined rank starting from the highest-scoring rank as the features of the photo image as in the above example, a collection of keywords having a score equal to or greater than a predetermined threshold may also be treated as the features of the photo image.

(B) As another example, a vector in which the scores of keywords computed according to any of the various methods indicated in the above (A) are arranged according to a predetermined keyword order may also be treated as the features of the photo image. The keyword order herein is the same as the sort order of keywords in the case of expressing the features of template images by sorting keywords by degree of association as exemplified in FIG. 3.

Note that in this example, the score is treated as 0 for keywords from among the keywords included in the keyword set that do not appear in the search result at all.

This method is based on the same idea as expressing the features of template images by sorting the degree of association of keywords for individual template images as exemplified in FIG. 3.

Next, an example of a method of computing the relevance of each template image to the photo image to be given a template by the template selector 110 will be described.

The basic idea is that a template image having features closer to the features of the photo image computed on the basis of the search result is more highly relevant to the photo image.

The relevance of the features of a template image to the features of the photo image is computed by a method that formally associates the respective features.

For example, in the case of the method that expresses the features of the photo image and a template image as a collection of related keywords, the number of keywords shared in common between the keyword group related to the photo image (computed by the above method (A)) and the keyword group related to the template image (computed from the stored content of the template/keyword association storage unit 114 illustrated in FIG. 2) may be treated as the relevance.

Also, for each keyword included in the keyword group related to a template image (see the example of FIG. 2), the score of the relevant keyword included in the feature vector of the photo image computed according to the above method (3) may be computed, and the result of summing the scores over all such keywords may be treated as the relevance of the template image to the photo image.

Also, the inner product of the feature vector of the photo image computed according to the above method (B) and a vector indicating the features of a template image as exemplified in FIG. 3 (in which keywords are sorted by degree of association) may be treated as the relevance. The inner product becomes a larger value for more similar vectors. The relevance computed in this way indicates a higher value for a template image having a feature vector that is more highly correlated with the feature vector of the photo image.

The template selector 110 automatically selects the template image with the highest relevance computed in this way, or presents several template images of higher relevance as candidates, and prompts the user to make a selection.

The above thus describes an exemplary embodiment of the template adding device 100. However, the exemplary embodiment described above is merely one example. For example, the format of the information stored in the template/keyword association storage unit 114 is not limited to that illustrated in FIG. 2 or FIG. 3. Also, the method of computing the relevance of each template image to the target photo image is not limited to the examples given above.

Also, in the foregoing exemplary embodiment, the image capture location information itself (also called a geotag) extracted from the photo image file is used as one element of the search key included in the search request to the search site 200. However, the image capture location information is a collection of the numerical values of latitude and longitude, and even if there exists posted information corresponding to the time and location of the event where the photo image was captured, the posted information may not include such numerical values (or a predetermined number of the most significant digits therefrom).

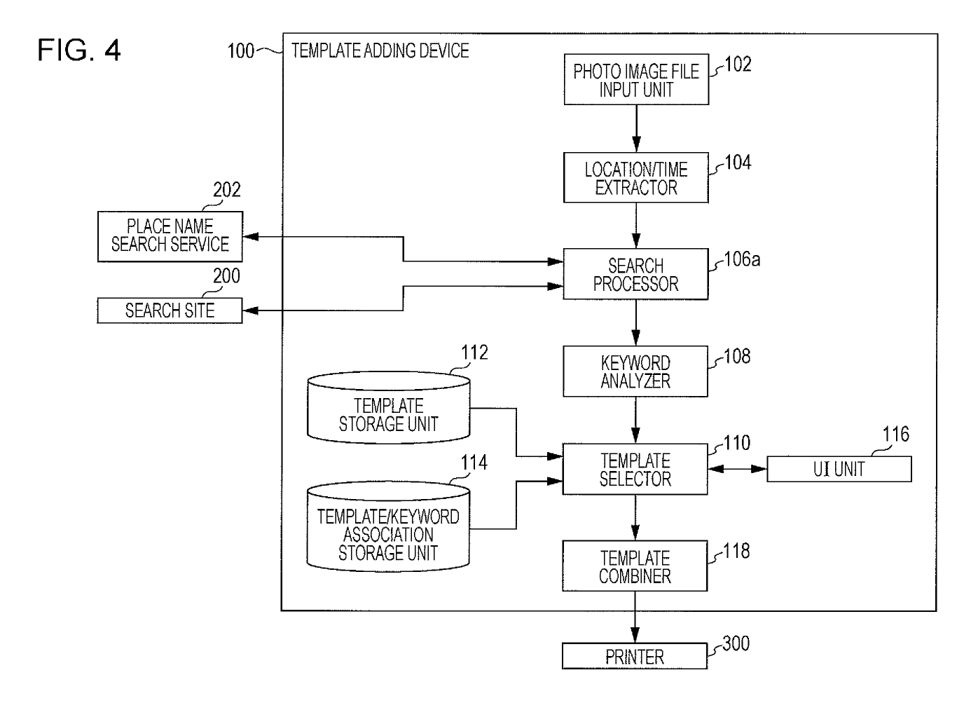

Accordingly, in the exemplary modification illustrated in FIG. 4, a search processor 106a transmits a search request including the latitude and longitude indicated by the image capture location information (geotag) extracted from the photo image file as a search condition to a place name search service 202 on the Internet. The place name search service 202 is a site that provides a service that searches map information for a place name, facility name (landmark name), or the like (hereinafter designated a “place name”) that corresponds to an input combination of latitude and longitude. Such a service is also called reverse geocoding. The search processor 106a receives place name information in the search result for the search request from the place name search service 202. Subsequently, the search processor 106a transmits a search request including the image capture time information extracted from the photo image file and a place name string received from the place name search service 202 as a search condition to the search site 200, and receives a search result corresponding to the search request.

In this way, by converting the latitude and longitude indicated by a geotag into a place name for use as the search condition, it becomes possible to retrieve more information on the Internet that corresponds to the image capture location of the photo image over the case of using the latitude and longitude as the search condition.

The details of processes executed by the elements other than the search processor 106a in the exemplary modification in FIG. 4 are similar to the processes of the elements denoted with the same signs in the exemplary embodiment in FIG. 1.

Note that in the above example, a place name retrieved by the place name search service 202 is included in the search condition to the search site 200 instead of the original latitude and longitude, but as another example, the retrieved place name and the original latitude and longitude may be joined by an OR condition and included in the search condition.

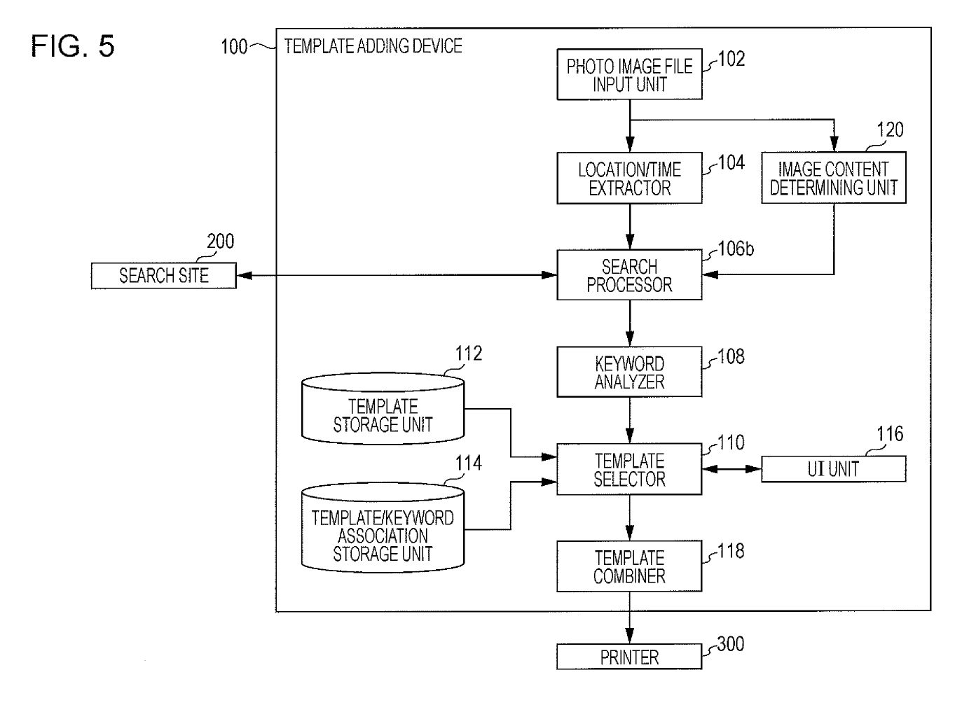

A template adding device 100 according to another exemplary modification is illustrated in FIG. 5. The template adding device 100 in FIG. 5 includes an image content determining unit 120. The image content determining unit 120 analyzes the photo image to be given a template that is input into the photo image file input unit 102, and categorizes the image content expressed by the photo image. This categorization includes determining whether or not the image content of the photo image corresponds to an image that takes a landscape as the photographic subject (called a landscape image).

Additionally, if the content of the photo image being processed is categorized as a landscape image, the search processor 106b reduces the precision of the image capture location information in the search condition to transmit to the search site 200 compared to the precision otherwise (for example, when the content of the photo image is categorized as a portrait image). In other words, the search processor 106b widens the geographical range indicated by the image capture location information in the search condition.

For example, if the latitude and longitude of the image capture location information are precise up to units of seconds, the precision of the image capture location information to include in the search condition is reduced to units of minutes, for example, or the precision is reduced by converting the last digit of the seconds unit to a wildcard (which matches any numeral from 0 to 9). Consequently, the geographical range of locations that match the image capture location information in the search condition widens.

By widening the range of locations indicated by image capture location information in the search condition in this way, information about events within a wider geographical range are retrieved in the search site 200 compared to the case of directly using the original image capture location information from the photo image file as the search condition.

For example, if the photo image is a portrait image, the location of the capturing camera is close to the location of the subject (one or more people), and the image capture location information acquired by the camera GPS indicates the location of the subject. In contrast, if the photo image is a landscape image, the subject is some kind of landmark in a landscape distant from the camera, and image capture location information acquired by the camera GPS may not indicate the location of the subject. Accordingly, in this exemplary modification, in the case of determining that the photo image is a landscape image, by widening the range of locations indicated by the image capture location information in the search condition, information about a wider geographical range is retrieved, and there is a higher probability that the location of the distant subject from the camera will be included in the geographical range of the search target.

In the determination of the image content determining unit 120, the image content determining unit 120 determines whether or not the photo image is an image that takes one or more people as the photographic subject (called a portrait image), and in the case of determining that the photo image is not a portrait image, decides that the photo image is a landscape image, for example. Technology of the related art may be used to determine whether or not the photo image is a portrait image. For example, commonly or publicly available face image recognition technology or full-body person image recognition technology may be used to extract image portions expressing a person's face or body. Subsequently, if the proportion of the total surface area of the photo image occupied by the face or body image portions is equal to or greater than a predetermined threshold, the photo image is determined to be a portrait image, and if not, the photo image is determined to be a landscape image. Since snapshot photos captured by ordinary people usually take a person or a landscape as the photographic subject, adequate functionality is obtained with such a determination.

However, the method that determines the photo image to be a landscape image when the photo image is not a portrait image as indicated above is merely one example.

The above is an example of the case of using latitude and longitude to express the image capture location information in the search condition to transmit to the search site 200, but the case of converting the latitude and longitude to a place name and transmitting the place name to the search site 200, as in the exemplary modification of FIG. 4, may be treated similarly.

For example, if the photo image is a landscape image, by lowering the precision of the latitude and longitude in the search condition transmitted from the search processor 106b to the place name search service 202 (omitted from illustration in FIG. 5), the range indicated by a place name that matches the search condition may be widened, or the number of matching place names may be increased. For example, if a search is conducted by directly using the latitude and longitude extracted from the photo image file, a place name may be identified down to the precision of the block and street number, or a single facility (such as a building or park) may be identified, for example. In contrast, if a search is conducted with a latitude and longitude of reduced precision, the precision of the retrieved place name may be reduced to the level of the block, and multiple blocks may be retrieved, or multiple facilities such as buildings may be retrieved. As a result, a place name that covers a wider range (or a set made up of multiple place names) is obtained compared to the case of searching at the original precision. The search processor 106b treats a place name that covers a wide range or a set of place names obtained in this way as the image capture location information in the search condition to transmit to the search site 200. In the case of multiple place names, the multiple place names may be joined by an OR condition in the search condition.

In the foregoing exemplary embodiment, a combined image of the photo image and a template image is printed and output from the printer 300, but the application of the combined image is not limited thereto. Instead, the combined image may be registered in an image sharing service or SNS on the Internet, or provided to the user as image data, for example. In the example of registering the combined image in a service on the Internet or providing the combined image to the user in this way, the photo image file input unit 102 may also accept the input of a photo image file via a network such as the Internet (for example, the photo image file input unit 102 may be a web server or the like that provides a webpage for photo registration).

In the foregoing exemplary embodiment, information of a keyword group computed from the search result of the search site 200, or in other words the features of the photo image, is used to filter a template image to apply to the photo image, but this is merely one example. Instead, the features of the photo image (for example, information computed according to the method (A) or (B) discussed earlier) may be configured as attribute information of the photo image (or the image obtained as a result of combining with a template image), for example. Attribute information may be embedded into a file such as the photo image, or registered in a database (such as an image sharing service or SNS, for example) as information associated with the photo image or the like, for example.

Also, in the foregoing exemplary embodiment and exemplary modifications, the search site 200 or place name search service 202 on the Internet is used to search for information related to image capture location information extracted from the photo image file, but similar search functionality may also be provided within the template adding device 100, or on an internal network of an organization in which the template adding device 100 is installed (for example, a local area network).

Information of the image capture direction may also be added as part of the search key. Recently, there exist cameras (or camera-equipped devices such as smartphones) that include a function enabling recording of not only the image capture location, but also the image capture direction. If an image capture direction is associated and recorded along with an image capture location in a photo image file captured by a camera that includes such functionality, by utilizing the image capture direction read from the photo image file as the search key for a search, it becomes possible to conduct a search limited to locations that exist in the image capture direction visible from the image capture location. Since the photographic subject generally exists at a location offset from the image capture location in the image capture direction, more accurate retrieval of information related to the photographic subject is anticipated in the case of utilizing image capture direction information for search.

Additionally, if the focus distance during image capture (the distance range to an in-focus subject) is recorded along with the image capture location, by utilizing focus distance information as the search key for a search, it becomes possible to conduct a search for a location separated from the image capture location by the focus distance.

Also, in the case of using both image capture direction information and focus distance information along with image capture location information for a search, it becomes possible to search for a location separated from the image capture location by the focus distance in the image capture direction.

If the focal length of the lens during image capture is also associated and recorded in addition to image capture location information, image capture direction information, and focus distance information, the distance from the focal length and the focus distance to the photographic subject may be estimated, making it possible to search for a location separated from the image capture location by the estimated distance in the image capture direction. Also, instead of directly using information such as the image capture location, image capture direction, focus distance, and focal length obtained from the photo image file as the search key, a range in which the photographic subject is thought to exist may be limited by the search processor 106, 106a, or 106b from the information obtained from the photo image file, and information specifying the limited range may be treated as the search key. For example, a location separated from the image capture location by the focus distance (or the distance to the subject estimated from the focal length and the focus distance) in the image capture direction may be specified, and information of the location may be passed to the search site 200 or the place name search service 202 as the search key (together with the image capture time).

Also, in the foregoing exemplary embodiment and exemplary modifications, the keyword analyzer 108 extracts keywords belonging to a predetermined keyword set from the information of the search result obtained from the search site 200, but this is merely one example. Instead, keywords belonging to the keyword set as well as synonyms may be extracted, and the number of extracted synonyms (the frequency of occurrence) may be reflected in the features of the photo image. At this point, the keywords and synonyms may be weighted equally, or the keywords may be weighted more than the synonyms. Also, for individual synonyms related to the same keyword, individual weights that differ according each synonym's closeness to the keyword may be applied.

The part of the template adding device 100 exemplified above that executes information processing may also be realized by causing a general-purpose computer to execute a program expressing the process of each function module of the relevant device, for example. The computer referred to herein includes hardware having a circuit configuration in which components such as a CPU or other microprocessor, memory such as random access memory (RAM) and read-only memory (ROM) (primary storage), an auxiliary storage controller that controls auxiliary storage such as a hard disk drive (HDD), a solid-state drive (SSD), or flash memory, various input/output (I/O) interfaces, and a network interface that conducts control for connecting to a wired or wireless network are interconnected via a bus, for example. Additionally, components such as a disc drive for reading and/or writing a portable disc recording medium such as a CD, DVD, or Blu-Ray Disc, or a memory reader/writer for reading and/or writing portable non-volatile recording media of various standards such as flash memory, may be connected to the bus via an I/O interface, for example. A program stating the processing details of each function module exemplified in the foregoing is saved in an auxiliary storage device such as flash memory and installed in the computer via a recording medium such as a CD or DVD, or via a communication medium such as a network. By having the CPU or other microprocessor load the program stored in the auxiliary storage device into RAM and execute the program, the function module group exemplified in the foregoing is realized.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for processing information, the process comprising:
storing keywords related to a template image for every template image;
acquiring a search result of information on the Internet that includes information of a location and a time that correspond to image capture location information and image capture time information included in photo image data; and
selecting a stored template image with related keywords that are highly relevant to a keyword group included in the search result as a template image relevant to the photo image data.

2. The non-transitory computer readable medium according to claim 1, wherein the process additionally comprises:
acquiring a place name or facility name that corresponds to latitude and longitude indicated by the image capture location information;
wherein the acquiring of a search result acquires a search result of information on the Internet that includes information of a location and a time that correspond to the acquired place name or facility name and the image capture time information.

3. The non-transitory computer readable medium according to claim 1, wherein
if the photo image data is a landscape image, the acquiring of a search result expands a location range indicated by the image capture location information compared to a case in which the photo image data is a portrait image, and acquires a search result of information on the Internet that includes information of a location and a time that correspond to the image capture location information of expanded range and the image capture time information.

4. The non-transitory computer readable medium according to claim 1, wherein the process additionally comprises:
associating at least one keyword included in the search result with the photo image data, or a combined image combining the photo image data with the selected template image, as attribute information.

5. An information processing device comprising:
memory that stores keywords related to a template image for every template image;
a search result acquisition unit that acquires a search result of information on the Internet that includes information of a location and a time that correspond to image capture location information and image capture time information included in photo image data; and
a selector that selects a template image with related keywords that are highly relevant to a keyword group included in the search result as a template image relevant to the photo image data and stored in the memory.

6. An information processing method comprising:
storing keywords related to a template image for every template image;
acquiring a search result of information on the Internet that includes information of a location and a time that correspond to image capture location information and image capture time information included in photo image data; and
selecting a template image with related keywords that are highly relevant to a keyword group included in the search result as a stored template image relevant to the photo image data.
